(19) United States
(12) Patent Application Publication
(10) Pub. No.: US 2017/0138433 A1
(43) Pub. Date: May 18, 2017

(54) DAMPING SPINDLE MECHANISM WITH SELF COMPENSATION

(71) Applicant: Xiangji WANG, Xiamen (CN)

(72) Inventors: Xiangji WANG, Xiamen (CN); Yuanhuai ZHANG, Xiamen (CN); Wencheng CHEN, Xiamen (CN); Yaohui LIN, Xiamen (CN)

(73) Assignee: Xiangji WANG, Xiamen (CN)

(21) Appl. No.: 15/127,688

(22) PCT Filed: Mar. 24, 2015
(86) PCT No.: PCT/CN2015/074930

§ 371 Date: Sep. 20, 2016

(30) Foreign Application Priority Data
Mar. 25, 2014 (CN) 201410114089.4
Mar. 25, 2014 (CN) 201420137851.6

(51) Int. Cl. F16F 9/50; E05F 3/20; E05F 3/04; F16F 9/14

(52) U.S. Cl. CPC F16F 9/50; F16F 9/14; E05F 3/20; E05F 3/04; E05Y 2900/614; A47K 13/12

(57) ABSTRACT

A damping spindle mechanism includes a spindle, a sleeve, a housing and a blade. The sleeve is coupled to the spindle; the housing is disposed with a chamber, one section of the spindle threaded with the sleeve is assembled in the chamber of the housing to form a closed chamber; the close chamber is filled with damping oil and is separated to a first chamber body and a second chamber body by the sleeve; the sleeve is disposed with a first passage connecting the two chamber bodies in the axial direction; wherein the blade is of ring shape or arc shape coupled to the internal wall surface of the housing, the blade is disposed with a deformable first thin wall. When the blade moves towards the second chamber body, the first thin wall deforms towards the internal wall surface of the housing.

### FIELD OF THE INVENTION

The present invention relates to a damping spindle mechanism, especially to a damping spindle mechanism that can rotate easily in a direction and be damped to rotate in the reverse direction with self compensation function.

### BACKGROUND OF THE INVENTION

Rotation connectors are widely used in varies fields, for example, they can be used in toilet seat cover, fridge door, telephone flip cover and cabinet door, etc, when used in toilet seat cover, the rotation connector connects the toilet seat cover and the toilet main body, there is no resistance when the toilet seat cover is flipped up or put down, it may causes that the toilet seat cover punches the toilet main body so hard when the user puts the toilet seat cover down, therefore, it easily damages the connecting portion of the toilet seat cover and the main body, on the other hand, it may also damage the toilet seat cover or the main body. For that reason, there is a rotation connector with a damping spindle mechanism, the most important feature of the damping spindle mechanism is that, it uses blade to serve as a check valve, when the damping spindle mechanism is applied in the toilet seat cover, the toilet seat cover is assembled to the main body by the damping spindle mechanism, when the rotating shaft rotates in a direction, the blade closes the main passage of the damping oil, the damping oil can just flow through the clearance between two chamber bodies, therefore, the damping oil flows slowly from one chamber body to the other chamber body, so that the seat cover drops down slowly, when the rotating shaft rotates to the opposite direction, the blade doesn't close the main passage of the damping oil, the damping oil flows through the main passage and the gap between the components, therefore, the damping oil flows quickly from the other chamber body to the chamber body, the seat cover is open quickly.

### SUMMARY OF THE INVENTION

The object of the present invention is to overcome the disadvantages of the existing known technology and to provide with a damping spindle mechanism with self compensation, with the self compensation, when the gap between the components is enlarged, it can automatically compensate the gap due to mechanical wear, thus making the damping spindle mechanism keep in a stable state in long period so as to lengthen the service life of the damping spindle mechanism.

The technical proposal of the present invention is that:

A damping spindle mechanism with self compensation, comprising a spindle, a sleeve, a housing and a blade; the sleeve is coupled to the spindle in thread way; the housing is disposed with a chamber, one section of the spindle threaded with the sleeve is assembled in the chamber of the housing to form a closed chamber; the close chamber is filled with damping oil and is separated to a first chamber body and a second chamber body by the sleeve; the sleeve is disposed with a first passage connecting the two chamber bodies in the axial direction; wherein the blade is of ring shape or arc shape coupled to the internal wall surface of the housing, the blade is disposed with a deformable first thin wall, when the blade moves towards the second chamber body, the first thin wall deforms towards the internal wall surface of the housing.

The internal wall of the sleeve is coupled to the external wall of the spindle, the internal wall of one end of the sleeve near the second chamber body is disposed with a second thin wall of deformation, when the sleeve moves towards the second chamber body, the thin wall deforms towards the external wall surface of the spindle. The blade is disposed with a first cavity adjacent to the first thin wall, the recess of the first cavity of the blade is faced to the second chamber body, so that when the blade moves towards the second chamber body, the recess of the first cavity opens the first thin wall outwards under the action of the damping oil.

The sleeve is disposed with a second cavity adjacent to the second thin wall, the recess of the second cavity of the sleeve is faced to the second chamber body, so that when the sleeve moves towards the second chamber body, the recess of the second cavity opens the second thin wall outwards under the action of the damping oil. An oil passage is disposed in the blade or between the blade and the sleeve.

The blade comprises at least two arc single bodies, the single bodies surrounds to a circle or the single bodies and the convex body of the sleeve surround to a circle so as to couple to the internal wall surface of the housing in a ring shape.

The section of the single body is V shaped, U shaped, E shaped, T shaped, W shaped or C shaped.

the oil passage is a first through hole disposed in the blade along the axial direction. The oil passage is disposed between the blade and the sleeve, the oil passage comprises a gap disposed at one single body of the blade and a first groove disposed at the sleeve corresponding to the gap.

The oil passage is disposed between the blade and the sleeve, the oil passage comprises a through groove once formed at the at least one end of the single body of the blade and a fitting surface of the convex body of the sleeve, the fitting surface is an incline surface.

The first passage is a second groove once formed at the external wall of the sleeve in the axial direction of the spindle.

The first passage is a second through hole disposed at the sleeve in the axial direction of the spindle.

The anti-rotation structure comprises a first rib disposed at the external wall of the sleeve in the axial direction and a second rib disposed at the internal wall of the housing in the axial direction, the first rib and the second rib are mismatched.

A second passage is disposed between the first chamber body and the second chamber body to connect the two chamber bodies, the section of the second passage is reducing, so that the flow constant of the damping oil in the second passage changes.

The second passage is disposed between the sleeve and the spindle.

The spindle is disposed with a central spindle with reducing internal diameter, the internal diameter reducing central spindle and the sleeve surround to form the second passage, the internal diameter of the central spindle with reducing internal diameter is gradually increased from the end near the first chamber body to the other end near the second chamber body; or in other case, the spindle is disposed with a central spindle with saltation internal diameter, the central spindle with saltation internal diameter and the sleeve surround to from the second passage, the internal diameter of the central spindle with saltation internal diameter is suddenly increased from the end near the first chamber body to the other end near the second chamber body.

The central spindle of the spindle is disposed with a gradually changing first slot in the axial direction, the gradually changing first slot and the sleeve surround to form the second passage, the gradually changing first slot is gradually narrowed from the end near the first chamber body to the other end near the second chamber body; or in other case, the central spindle of the spindle is a gradient second slot in the axial direction, the gradient second slot and the sleeve surround to form the second passage, the gradient second slot is gradiently narrowed from the end near the first chamber body to the other end near the second chamber body.

The external thread of the spindle is disposed with gradually changing third slot in the thread direction, the gradually changing third slot and the sleeve surround to form the second passage, the gradually changing third slot is gradually narrowed in screw way from the end near the first chamber body to the other end near the second chamber body.

The second passage is disposed between the sleeve and the housing.

The housing is disposed with a chamber body with internal diameter gradually changing, the chamber wall of the chamber body with internal diameter gradually changing and the sleeve surround to form the second passage, the internal diameter of the chamber body with internal diameter gradually changing is gradually narrowed from the end near the first chamber body to the other end near the second chamber body; or in other case, the housing is disposed with a chamber body with saltation internal diameter, the chamber wall of the chamber body with saltation internal diameter and the sleeve surround to form the second passage, the internal diameter of the chamber body with saltation internal diameter is suddenly decreased from the end near the first chamber body to the other end near the second chamber body.

The chamber wall of the chamber body of the housing is disposed with a gradually changing fourth slot in the axial direction, the gradually changing fourth slot and the sleeve surround to form the second passage, the gradually changing fourth slot is gradually narrowed from the end near the first chamber body to the other end near the second chamber body; or in other case, the chamber wall of the chamber body of the housing is disposed with a gradient fifth slot in the axial direction, the gradient fifth slot and the sleeve surround to form the second passage, the gradient fifth slot is gradiently narrowed from the end near the first chamber to the other end near the second chamber body.

The damping spindle mechanism with self compensation of the present invention plays self compensation via disposing thin walls structure in the sleeve and the blade, the thin walls of the blade and the sleeve are respectively coupled to the coupling surface of the housing and the spindle, under the action of pressure, the thin walls deforms slightly. When the spindle rotates, the spindle drives the sleeve and the blade to move forth and back by the screw mechanism, in damping state, the spindle rotates in a direction to drive the sleeve to move towards the second chamber body, the space of the second chamber body is gradually decreased, the pressure of the damping oil of the second chamber body is increased, at the same time, the space of the first chamber body is gradually increased, the pressure of the damping oil in the first chamber body is decreased, due to the pressure difference, the damping oil in the second chamber body moves to the first chamber body, the moving chamber body pushes the blade to the first passage, the blade closes the first passage, on the other hand, the damping oil with increasing oil pressure moves to the first cavity, the recess of the first cavity makes the first thin wall expanding outwardly under the action of the damping oil pressure, so that the first thin wall deforms towards the internal wall surface of the housing, so as to compensate the gap between the blade and the housing due to mechanical wear after long period, at the same way, the damping oil with increased oil pressure moves to the second cavity, the recess of the second cavity makes the second thin wall expanding outwardly under the action of the damping oil pressure, so that the second thin wall deforms towards the external wall surface of the spindle, so as to compensate the gap between the spindle and the sleeve due to mechanical wear after long period, therefore, the damping oil from the second chamber body to the first chamber body can only flow through the oil passage of the blade, or the oil passage between the blade and the sleeve, or the preset gap between the blade and the housing and/or the gap between the spindle and the sleeve, the damping oil can keep in a constant volume during long period's usage, that is to say, with the thin wall structure's deforming, it obtains self compensation. When the spindle rotates in the opposite direction, the sleeve moves towards the first chamber body, the space in the first chamber body is gradually decreased, the pressure of the damping oil in the first chamber body is increased, at the same time, the space of the second chamber body is gradually increased, the pressure of the damping oil in the second chamber body is decreased, due to the pressure difference, the damping oil of the first chamber body moves to the second chamber body, the moving damping oil pushes the blade away from the first passage, the first passage is open, the damping oil decompresses quickly, that is to say, the damping oil moves quickly from the first chamber body to the second chamber body, meanwhile, as the pressure of the damping oil of the first cavity and the second cavity is low, the self compensation structure doesn't act, therefore, no damping exists when the spindle rotates in the opposite direction. The blade moves forth and back at the sleeve, it serves as a check valve.

Compared to the existing known technology, the technical proposal of the present invention has advantages as follows:

1. as the present invention is provided that the blade is disposed with a deformable first thin wall, the sleeve is disposed with a deformable second thin wall, a first cavity is disposed adjacent to the first thin wall, a second cavity is disposed adjacent to the second thin wall, the recess of the first cavity and the second cavity have special direction, the first thin wall is coupled to the coupling surface of the housing, the second thin wall is coupled to the coupling surface of the spindle, the self compensation structure can makes the first thin wall deformed towards the internal wall surface of the housing and the second thin wall deformed towards the external wall surface of the spindle in damping state, so as to automatically compensate the gap due to mechanical wear, thus keeping the damping spindle mechanism in a stable state in long period so as to lengthen the service life of the damping spindle mechanism.

2. The present invention is provided that the blade is composed of at least two arc shaped single bodies, each single body and the convex body of the sleeve surround to a circle so as to couple to the internal wall surface of the housing in a ring shape, at least one end of at least one single body of the blade is once formed with a through groove, the through groove is coupled to the coupling surface of the convex body of the sleeve to form an oil passage, the coupling surface is inclined, so that when the blade closes the first passage, the section area of the oil passage is small, when the blade opens the first passage, the section area of the oil passage is larger, it thus efficiently ensures that the spindle mechanism rotates quickly in a direction and rotates slowly in the opposite direction.

3. The present invention is provided that a second passage is disposed to connect the two chamber bodies between the first chamber body and the second chamber body, as the section of the second passage changes, the flow rate of the damping oil in the second passage changes, with this structure, the spindle mechanism can be designed fast followed by slow during the slowly rotating by preset to achieve better effect.

The present invention will be further described with the drawings and the embodiments; but it should be noted that, the scope of the present invention is not limited to the embodiments.

### BRIEF DESCRIPTION OF THE DRAWINGS

FIG. 1 illustrates an exploded and schematic diagram of the first embodiment of the present invention.

FIG. 2 illustrates a schematic diagram of the first embodiment of the present invention assembled to the toilet seat cover.

FIG. 3 illustrates a sectional diagram of the first embodiment of the present invention when the toilet seat cover is totally flipped up;

FIG. 4 illustrates a sectional diagram of the first embodiment of the present invention when the toilet seat cover is closing.

FIG. 5 illustrates a sectional diagram of the first embodiment of the present invention when the toilet seat cover is totally closed.

FIG. 6 illustrates a sectional diagram of the first embodiment of the present invention when the toilet seat cover is being flipped up.

FIG. 7 illustrates a schematic diagram of the spindle of the first embodiment of the present invention.

FIG. 8 illustrates a sectional diagram of the spindle of the first embodiment of the present invention.

FIG. 9 illustrates a schematic diagram of the sleeve of the first embodiment of the present invention.

FIG. 10 illustrates a sectional diagram of the sleeve of the first embodiment of the present invention.

FIG. 11 illustrates a schematic diagram of the blade and sleeve when coupling to each other of the first embodiment of the present invention.

FIG. 12 illustrates a sectional diagram of the blade and the sleeve when coupling to each other of the first embodiment of the present invention, the upper portion in the drawing illustrates the blade in open state, the lower portion in the drawing illustrates the blade in closed state.

FIG. 13 illustrates a schematic diagram of the spindle of the second embodiment of the present invention.

FIG. 14 illustrates a sectional diagram of the second embodiment of the present invention.

FIG. 15 illustrates a schematic diagram of the spindle of the third embodiment of the present invention.

FIG. 16 illustrates a sectional diagram of the spindle of the third embodiment of the present invention.

FIG. 17 illustrates a schematic diagram of the spindle of the fourth embodiment of the present invention.

FIG. 18 illustrates a sectional diagram of the spindle of the fourth embodiment of the present invention.

FIG. 19 illustrates a schematic diagram of the spindle of the fifth embodiment of the present invention.

FIG. 20 illustrates a sectional diagram of the housing of the sixth embodiment of the present invention.

FIG. 21 illustrates a sectional diagram of the housing of the seventh embodiment of the present invention.

FIG. 22 illustrates a schematic diagram of the housing of the eighth embodiment of the present invention.

FIG. 23 illustrates a sectional diagram of the housing of the eighth embodiment of the present invention.

FIG. 24 illustrates a schematic diagram of the housing of the ninth embodiment of the present invention.

FIG. 25 illustrates a sectional diagram of the housing of the ninth embodiment of the present invention.

FIG. 26 illustrates a schematic diagram of the sleeve of the tenth embodiment of the present invention.

FIG. 27 illustrates a sectional diagram of the sleeve of the tenth embodiment of the present invention.

FIG. 28 illustrates a schematic diagram of the blade of the eleventh embodiment of the present invention.

FIG. 29 illustrates a sectional diagram of the blade of the eleventh embodiment of the present invention.

FIG. 30 illustrates a schematic diagram of the blade and the sleeve when coupling to each other of the twelfth embodiment of the present invention.

FIG. 31 illustrates a sectional diagram of the blade and the sleeve when coupling to each other of the twelfth embodiment of the present invention.

### DETAILED DESCRIPTION OF THE EMBODIMENTS

### The First Embodiment

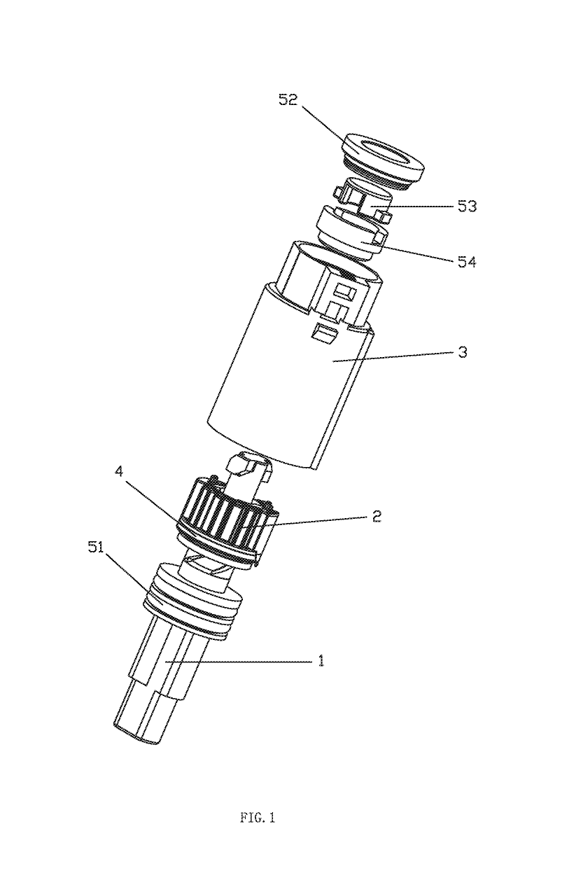

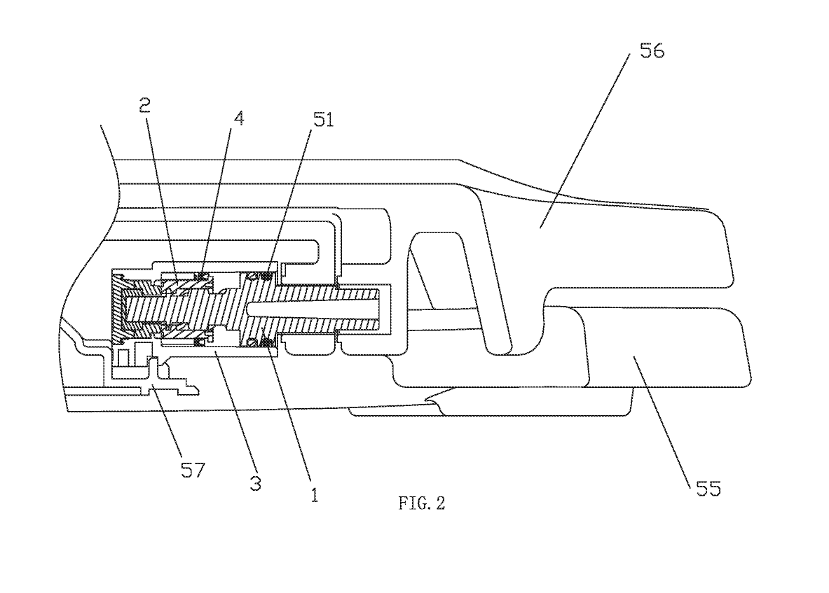

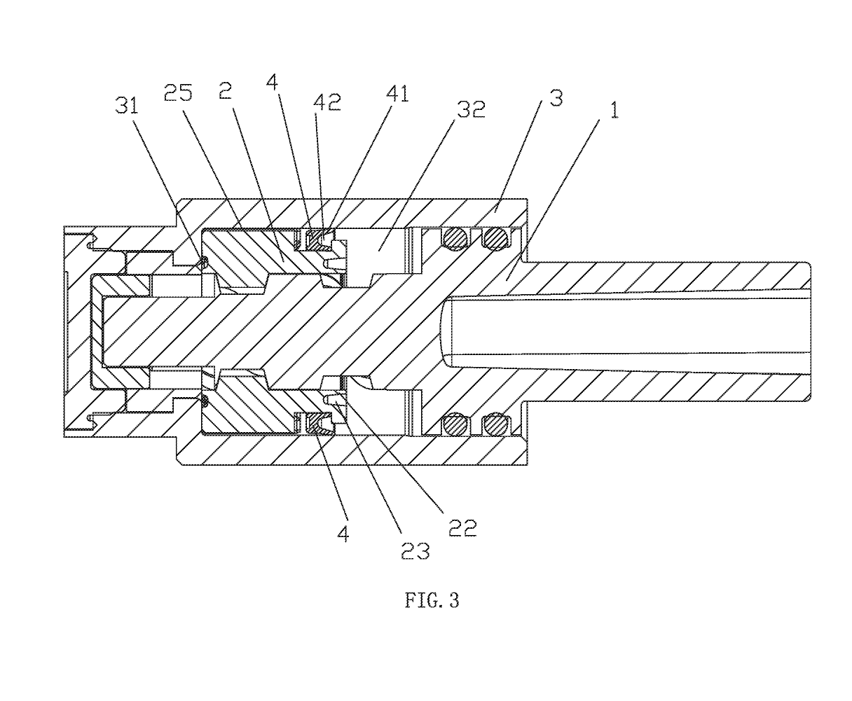

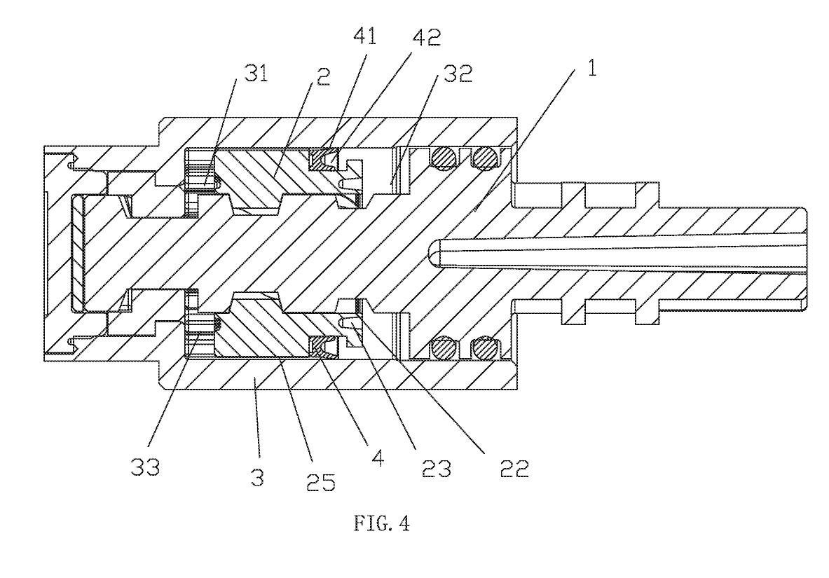

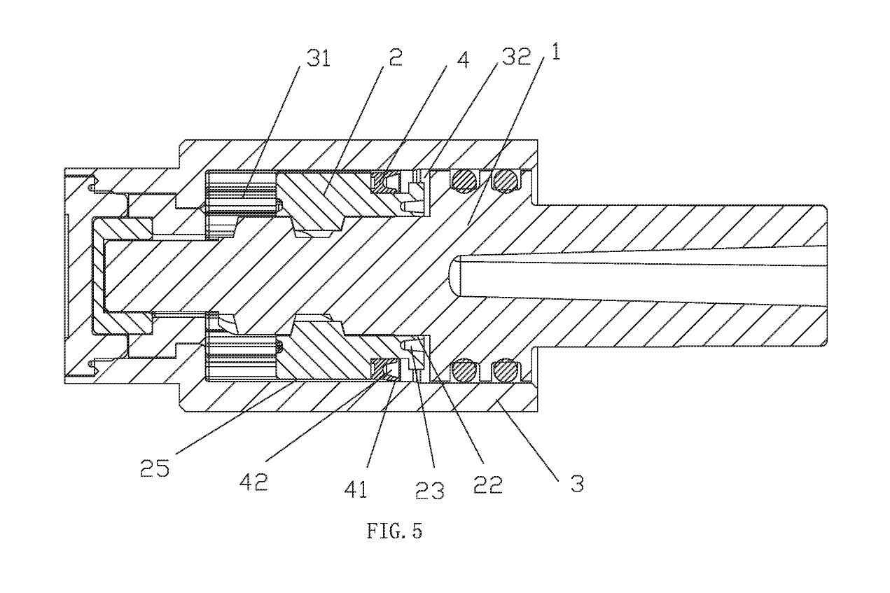

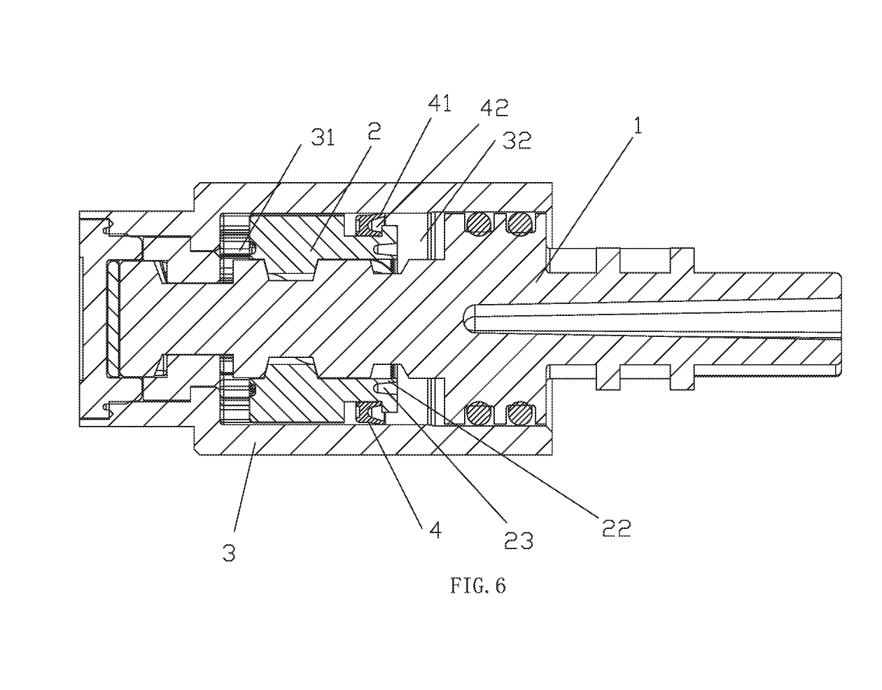

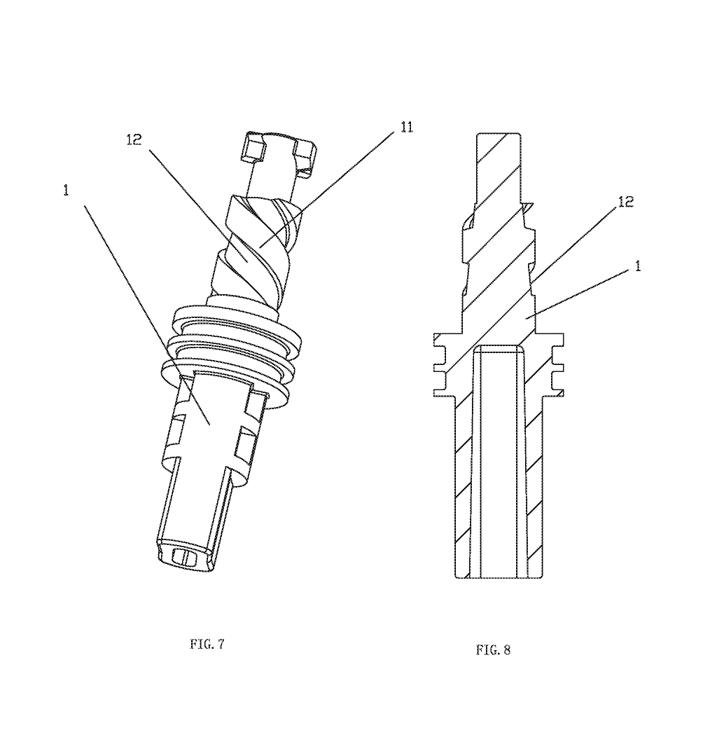

Referring to FIGS. 1-12, the damping spindle mechanism with self compensation of the present invention comprises a spindle 1, a sleeve 2, a housing 3 and a blade 4; the sleeve 2 is coupled to the spindle 1 in thread way, that is to say, the spindle 1 is disposed with an external thread 11, the sleeve 2 is disposed with an internal thread 21; the housing 3 is disposed with a chamber, one section of the spindle 1 threaded to the sleeve 2 is assembled in the chamber of the housing and making the chamber a closed chamber, one end of the spindle 1 is inserted to the chamber of the housing 3, t a welding cover 52, a fixing block 53 and a fixing element 54 are used to support the end of the spindle 1 and also used to close one end of the chamber, the other end of the chamber is closed by a sealing ring 51, making the chamber of the housing a closed internal chamber; an anti-rotation structure is disposed between the sleeve 2 and the housing 3, when the spindle 1 rotates, the sleeve 2 moves forward and backward along the axis of the spindle in the housing 3; the closed chamber is filled with damping oil, the closed chamber is separated into a first chamber body 31 and a second chamber body 32 by the sleeve 2; the sleeve 2 is disposed with a first passage in the axial direction to connect the two chamber bodies; the blade 4 is movably assembled to the sleeve 2, it is disposed at the side of the first passage near the second chamber body, the first passage is closed and open by the blade gets closed to the first passage and gets away from the first passage; the blade 4 is ring shaped or arc shaped and coupled to the internal wall surface of the close chamber of the housing 3, the blade 4 is disposed with a deformable first thin wall 41, when the blade 4 moves towards the second chamber body 32, the first thin wall 41 expands towards the internal wall surface of the housing.

The internal wall of the sleeve 2 is coupled to the external wall of the spindle 1, the internal wall of the end of the sleeve 2 near the second chamber body is disposed with a deformable second thin wall 22, when the sleeve 2 moves towards the second chamber body 32, the second thin wall 22 deforms towards the external wall surface of the spindle 1.

The blade 4 is disposed with a first cavity 42 adjacent to the first thin wall 41, the recess of the first cavity 42 of the blade 4 is faced to the second chamber body, so that when the blade 4 moves towards the second chamber body, the recess of the first cavity opens the first thin wall 41 outwards under the action of the damping oil. The sleeve is disposed with a second cavity 23 adjacent to the second thin wall 22, the recess of the second cavity 23 of the sleeve is faced to the second chamber body, so that when the sleeve 2 moves towards the second chamber body, the recess of the second cavity 23 opens the second thin wall 22 outwards under the action of the damping oil.

An oil passage is disposed in the blade or between the blade and the sleeve. In this embodiment, the blade comprises two arc single bodies 40, the single bodies 40 surrounds to a circle, same as this embodiment, the sleeve 2 is disposed with two convex bodies 24, the two arc single bodies 40 and the two convex body 24 of the sleeve 2 surround to a circle so as to couple to the internal wall surface of the housing in a ring shape.

In this embodiment, the section of the single body is V shaped, as needed, it can be also U shaped, E shaped, T shaped, W shaped or C shaped, or it can be an integral whole.

The oil passage is disposed between the blade 4 and the sleeve 2, the oil passage comprises a through groove 43 once formed at the at least one end of the single body of the blade and a fitting surface 241 of the convex body 24 of the sleeve, the fitting surface 241 is an incline surface.

The first passage is a second groove 25 once formed at the external wall of the sleeve in the axial direction of the spindle.

The anti-rotation structure comprises a first rib 26 disposed at the external wall of the sleeve in the axial direction and a second rib 33 disposed at the internal wall of the housing in the axial direction, the first rib 26 and the second rib 33 are mismatched.

A second passage is disposed between the first chamber body 31 and the second chamber body 32 to connect the two chamber bodies, the section of the second passage is reducing, so that the flow constant of the damping oil in the second passage changes.

The second passage is disposed between the sleeve and the spindle.

The spindle 1 is disposed with a central spindle 12 with reducing internal diameter, the internal diameter reducing central spindle 12 and the sleeve 2 surround to form the second passage, the internal diameter of the central spindle 12 with reducing internal diameter is gradually increased from the end near the first chamber body to the other end near the second chamber body.

The damping spindle mechanism with self compensation of the present invention is assembled between the toilet seat cover and the base 57, the toilet seat cover comprises a seatring 55 and an upper cover 56, the housing 3 of the present invention is fixed to the base 57, the spindle 1 of the present invention is fixed to the toilet seat cover.

The damping spindle mechanism with self compensation of the present invention plays self compensation via disposing thin walls structure in the sleeve 2 and the blade 4, the thin walls of the blade 4 and the sleeve 2 are respectively coupled to the coupling surface of the housing and the spindle 1, under the action of pressure, the thin walls deforms slightly. When the spindle 1 rotates, the spindle 1 drives the sleeve 2 and the blade 4 to move forth and back by the screw mechanism, in dropping slowly state, the spindle 1 rotates in a direction to drive the sleeve 2 to move towards the second chamber body 32, the space of the second chamber body 32 is gradually decreased, the pressure of the damping oil of the second chamber body 32 is increased, at the same time, the space of the first chamber body 31 is gradually increased, the pressure of the damping oil in the first chamber body 31 is decreased, due to the pressure difference, the damping oil in the second chamber body 32 moves to the first chamber body 31, the moving chamber body pushes the blade 4 to the first passage (the port of one end of the second groove 25), the blade 4 closes the first passage, on the other hand, the damping oil with increasing oil pressure moves to the first cavity 42, the recess of the first cavity 42 makes the first thin wall 41 expanding outwardly under the action of the damping oil pressure, so that the first thin wall 41 deforms towards the internal wall surface of the housing, so as to compensate the gap between the blade 4 and the housing due to mechanical wear after long period, at the same way, the damping oil with increased oil pressure moves to the second cavity 23, the recess of the second cavity 23 makes the second thin wall 22 expanding outwardly under the action of the damping oil pressure, so that the second thin wall 22 deforms towards the thread surface of the spindle 1, so as to compensate the gap between the spindle 1 and the sleeve 2 due to mechanical wear after long period, therefore, the damping oil from the second chamber body 32 to the first chamber body 31 can only flow through the oil passage of the blade 4, or the oil passage between the blade 4 and the sleeve 2, or the preset gap between the blade 4 and the housing and/or the gap between the spindle 1 and the sleeve 2, the damping oil can keep in a constant volume during long period's usage, that is to say, with the thin wall structure's deforming, it obtains self compensation. When the spindle 1 rotates in the opposite direction, the sleeve 2 moves towards the first chamber body 31, the space in the first chamber body 31 is gradually decreased, the pressure of the damping oil in the first chamber body 31 is increased, at the same time, the space of the second chamber body 32 is gradually increased, the pressure of the damping oil in the second chamber body 32 is decreased, due to the pressure difference, the damping oil of the first chamber body 31 moves to the second chamber body 32, the moving damping oil pushes the blade 4 away from the first passage (the port of one end of the second groove 25), the first passage is open, the damping oil decompresses quickly, that is to say, the damping oil moves quickly from the first chamber body 31 to the second chamber body 32, meanwhile, as the pressure of the damping oil of the first cavity 42 and the second cavity 23 is low, the self compensation structure doesn't act, therefore, it can reduce the resistance when the seat cover is flipped up. The blade 4 moves forth and back at the sleeve 2, it serves as a check valve.

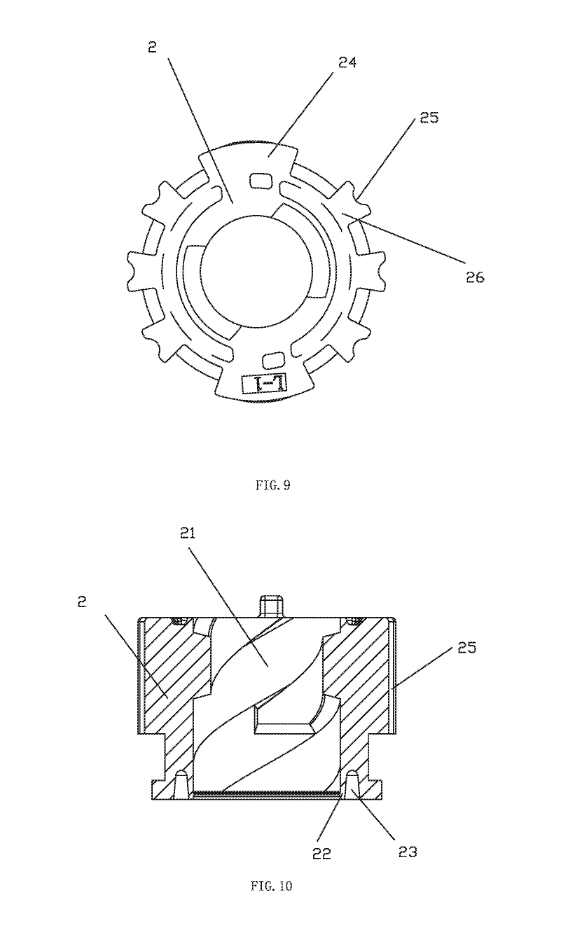

The present invention is provided that the blade is composed oft two arc shaped single bodies, two single bodies 40 and the convex body 24 of the sleeve surround to a circle so as to couple to the internal wall surface of the housing in a ring shape, at least one end of at least one single body of the blade 4 is once formed with a through groove 43, the through groove 43 is coupled to the coupling surface 241 of the convex body 24 of the sleeve to form an oil passage, the coupling surface is inclined, so that when the blade 4 closes the first passage, the section area of the oil passage 61 is small, as figured in FIG. 12, when the blade 4 opens the first passage, the section area of the oil passage 62 is larger, as figured in FIG. 12, it thus efficiently ensures that the seat cover lifts up quickly and drops down slowly.

The damping spindle mechanism with self compensation of the present invention is provided that the second passage disposed between the first chamber body 31 and the second chamber body 32 is used to connect the two chamber bodies, the section of the second passage has changing diameter, so that the flow rate of the damping oil is changed in the second passage. The spindle 1 of the present invention is disposed with a central spindle 12 with reducing internal diameter, the internal diameter reducing central spindle 12 and the sleeve 2 surround to form the second passage, the internal diameter of the central spindle 12 with reducing internal diameter is gradually increased from the end near the first chamber body to the other end near the second chamber body. So that the section area of the second passage is gradually narrowed from the end near to the first chamber body to the end near to the second chamber body, when the seat cover drops down at the beginning, it has the largest section area of the second passage, the damping oil in the second chamber body 32 flows quickly to the first chamber body 31, the resistance to the seat cover is weak, with the seat cover drops down, the section area of the second passage gradually decreases, the resistance to the seat cover gradually increases, at the end of the dropping of the seat cover, the resistance to the seat cover is the largest, it slows down the dropping of the seat cover with well effect.

### The Second Embodiment

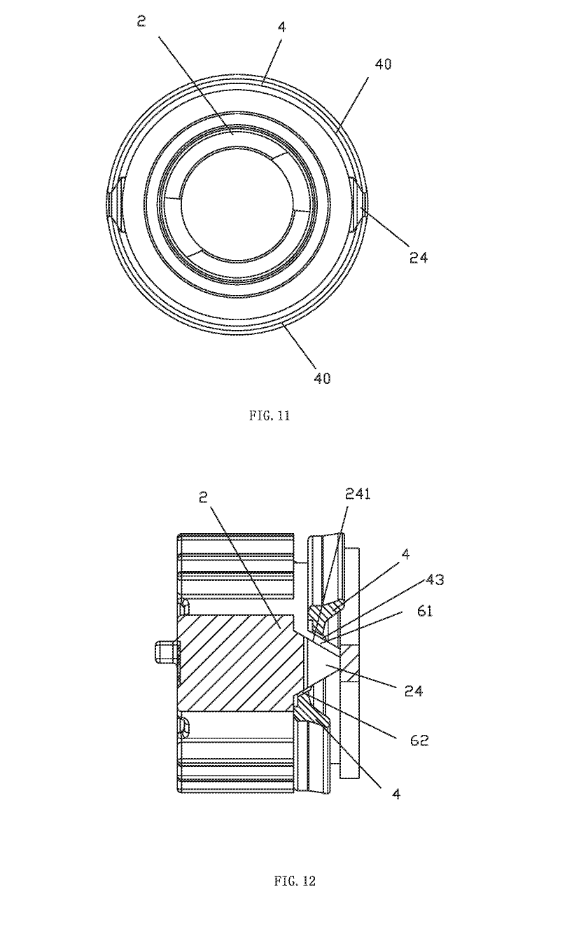

As figured in FIG. 13 and FIG. 14, the damping spindle mechanism with self compensation of this embodiment differs from the first embodiment in that: the spindle 1 is not applied with the central spindle with internal diameter gradually changed, but a central spindle 13 with saltation internal diameter, the central spindle 13 with saltation internal diameter and the sleeve 2 surround to from the second passage, the internal diameter of the central spindle 13 with saltation internal diameter is suddenly increased from the end near the first chamber body to the other end near the second chamber body.

### The Third Embodiment

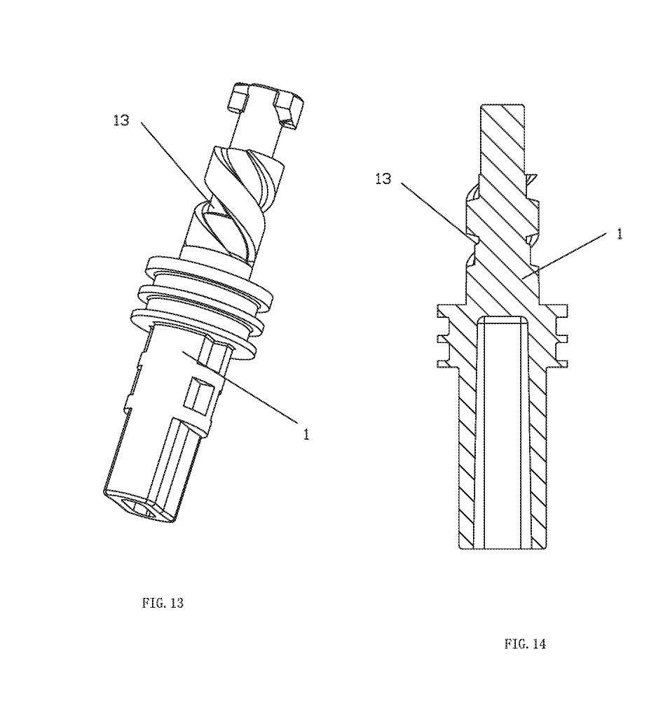

Referring to FIG. 15 and FIG. 16, the damping spindle mechanism with self compensation of this embodiment differs from the first embodiment in that: the spindle 1 is not applied with the central spindle with internal diameter gradually changed, but a gradually changing first slot 14 in the axial direction, the gradually changing first slot 14 and the sleeve 2 surround to form the second passage, the gradually changing first slot 14 is gradually narrowed from the end near the first chamber body to the other end near the second chamber body

### The Fourth Embodiment

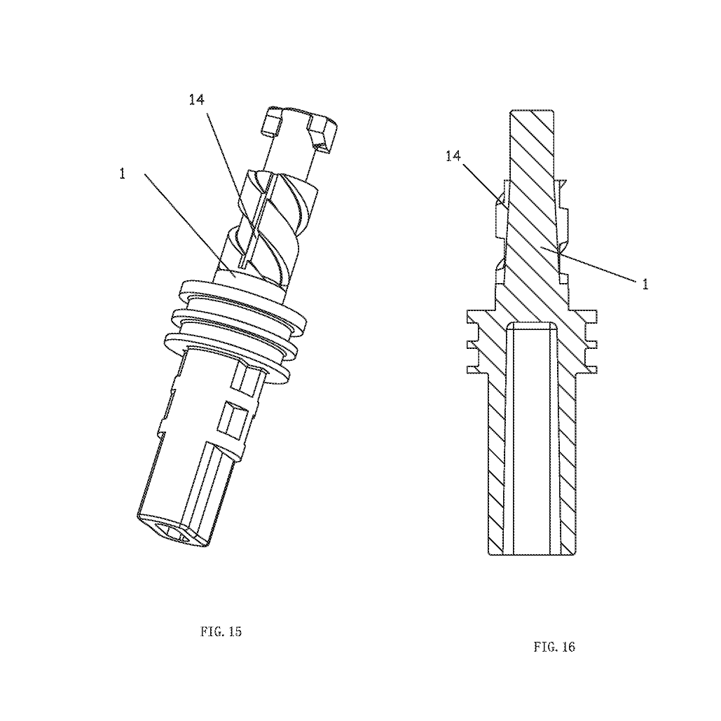

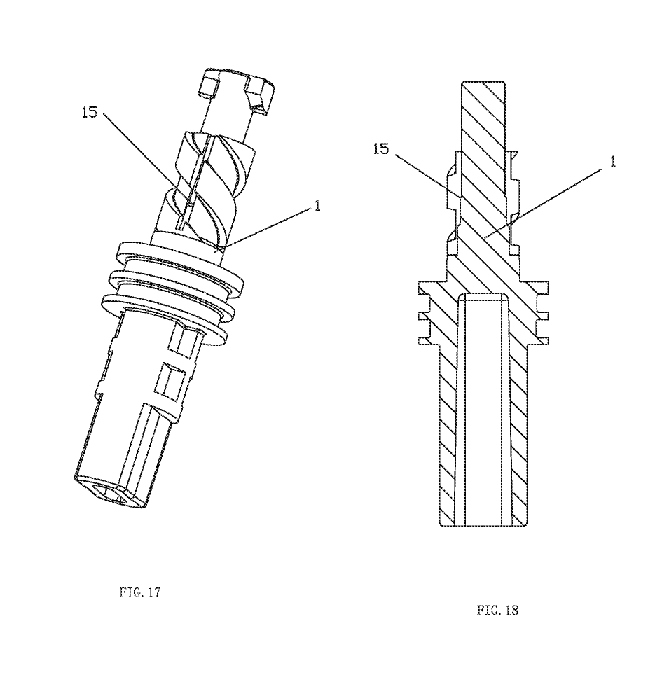

Referring to FIG. 17 and FIG. 18, the damping spindle mechanism with self compensation of this embodiment differs from the first embodiment in that: the spindle 1 is not applied with the central spindle with internal diameter gradually changed, but a gradient second slot 15 in the axial direction, the gradient second slot 15 and the sleeve surround to form the second passage, the gradient second slot 15 is gradiently narrowed from the end near the first chamber body to the other end near the second chamber body

### The Fifth Embodiment

Referring to FIG. 19, the damping spindle mechanism with self compensation of this embodiment differs from the first embodiment in that: the spindle 1 is not applied with the central spindle with internal diameter gradually changed, but not a spindle with internal diameter gradually changed, the external thread 11 of the spindle is disposed with gradually changing third slot 16 in the thread direction, the gradually changing third slot 16 and the sleeve 2 surround to form the second passage, the gradually changing third slot 16 is gradually narrowed in screw way from the end near the first chamber body to the other end near the second chamber body.

### The Sixth Embodiment

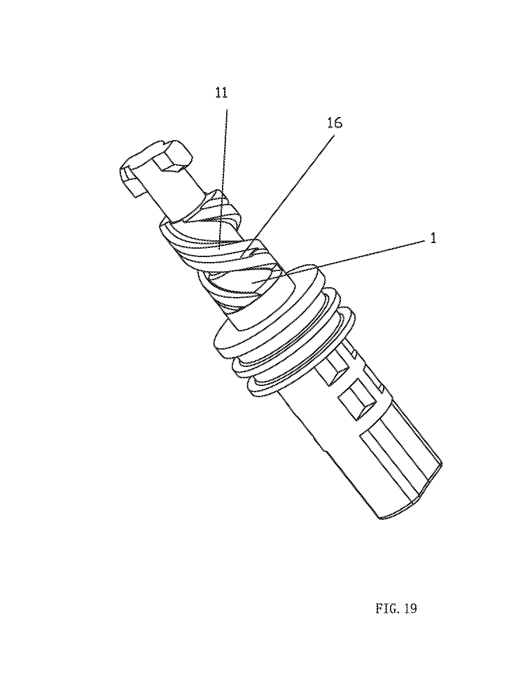

Referring to FIG. 20, the damping spindle mechanism with self compensation of this embodiment differs from the first embodiment in that: another second passage is disposed between the sleeve and the housing, so that the structure of the housing is different from that of the first embodiment, the housing 3 is disposed with a chamber body 34 with internal diameter gradually changing, the chamber wall of the chamber body 34 with internal diameter gradually changing and the sleeve 2 surround to form the second passage, the internal diameter of the chamber body 34 with internal diameter gradually changing is gradually narrowed from the end near the first chamber body to the other end near the second chamber body. In this embodiment, there are two second passages, one is surrounded by the central spindle 12 with gradually changing internal diameter and the sleeve 2, the other one is surrounded by the chamber wall of the chamber body 34 with gradually changing internal diameter and the sleeve 2, it can be also disposed with only one second passage, such as the second passage surrounded by the chamber wall of the chamber body 34 with gradually changing internal diameter and the sleeve 2, therefore, the spindle has the internal diameter with same size.

### The Seventh Embodiment

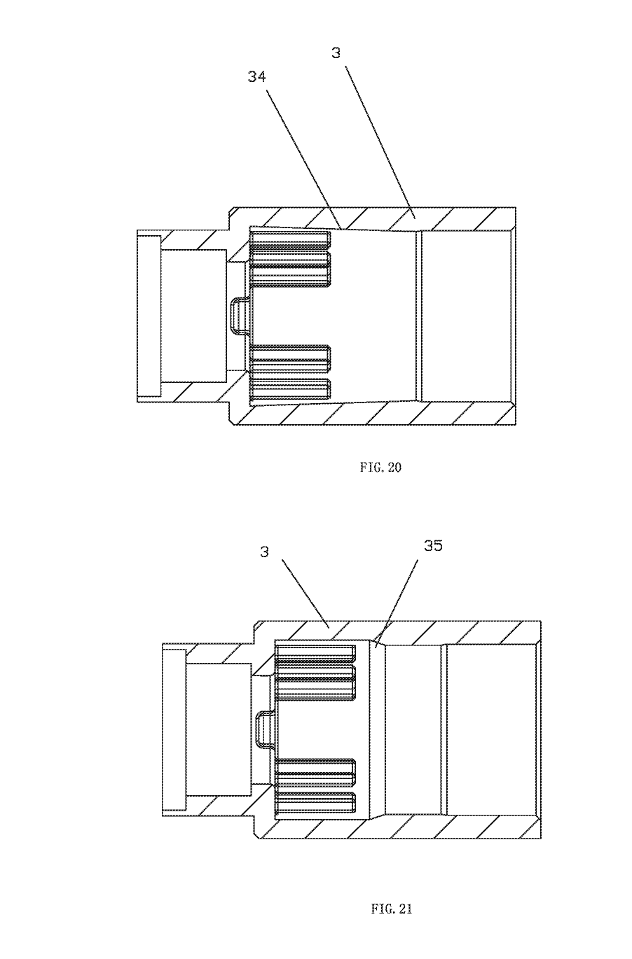

Referring to FIG. 21, the damping spindle mechanism with self compensation of this embodiment differs from the sixth embodiment in that: the housing is not disposed with a chamber body with gradually changing internal diameter, but the housing 3 is disposed with a chamber body 35 with saltation internal diameter, the chamber wall of the chamber body 35 with saltation internal diameter and the sleeve 2 surround to form the second passage, the internal diameter of the chamber body 35 with saltation internal diameter is suddenly decreased from the end near the first chamber body to the other end near the second chamber body.

### The Eighth Embodiment

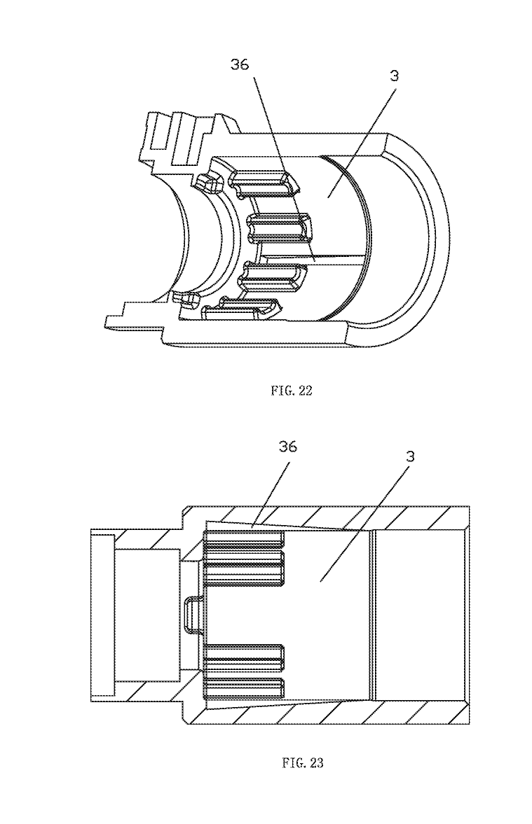

Referring to FIG. 22 and FIG. 23, the damping spindle mechanism with self compensation of this embodiment differs from the sixth embodiment in that: the housing is not disposed with a chamber body with gradually changing internal diameter, but the chamber wall of the chamber body of the housing 3 is disposed with a gradually changing fourth slot 36 in the axial direction, the gradually changing fourth slot 36 and the sleeve 2 surround to form the second passage, the gradually changing fourth slot 36 is gradually narrowed from the end near the first chamber body to the other end near the second chamber body

### The Ninth Embodiment

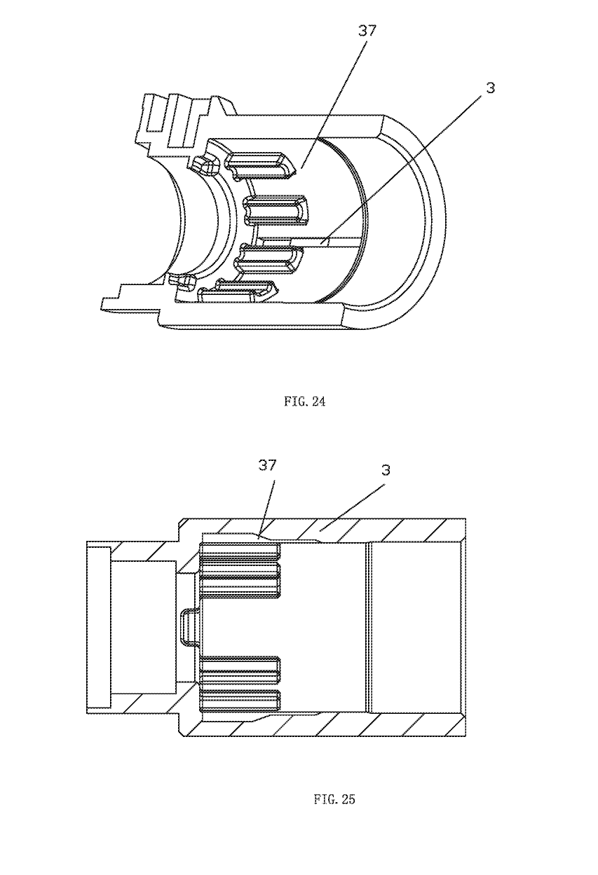

Referring to FIG. 24 and FIG. 25, the damping spindle mechanism with self compensation of this embodiment differs from the sixth embodiment in that: the housing is not disposed with a chamber body with gradually changing internal diameter, but the chamber wall of the chamber body of the housing 3 is disposed with a gradient fifth slot 37 in the axial direction, the gradient fifth slot 37 and the sleeve 2 surround to form the second passage, the gradient fifth slot 37 is gradiently narrowed from the end near the first chamber to the other end near the second chamber body.

### The Tenth Embodiment

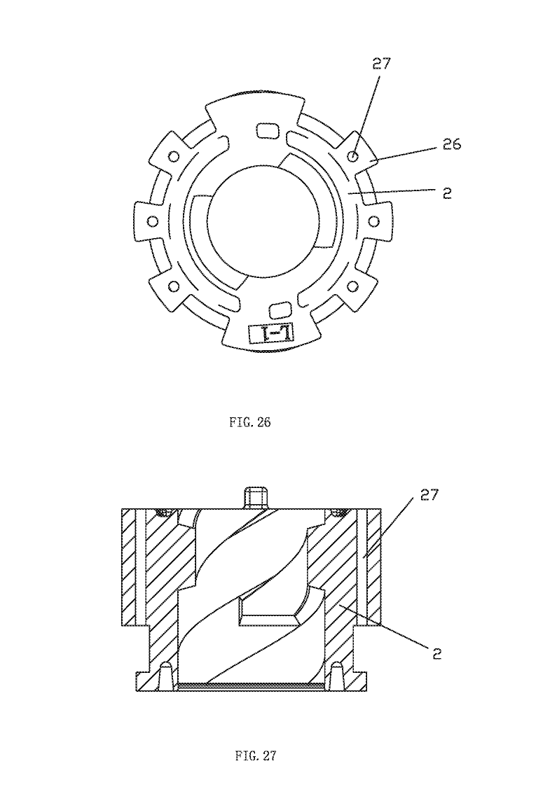

Referring to FIG. 26 and FIG. 27, the damping spindle mechanism with self compensation of this embodiment differs from the first embodiment in that: the first passage is a second through hole 27 disposed at the sleeve 2 in the axial direction of the spindle.

### The Eleventh Embodiment

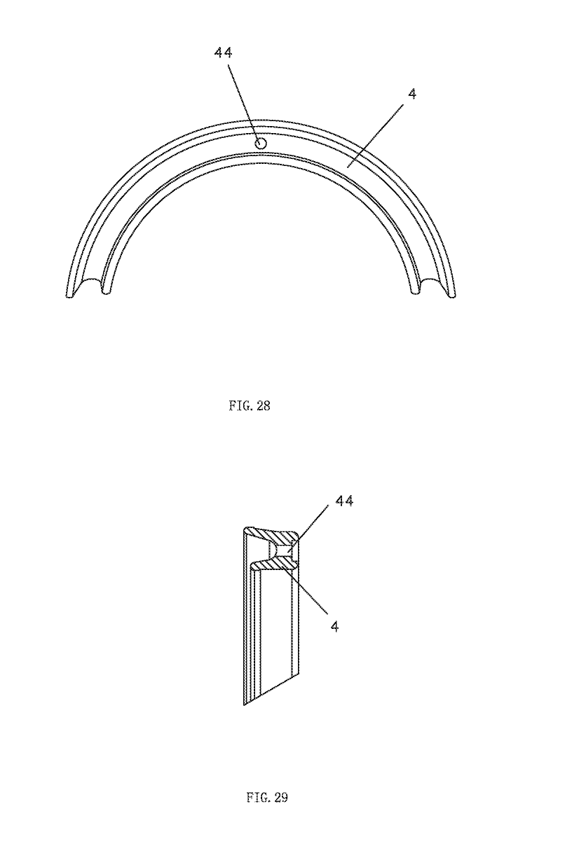

Referring to FIG. 28 and FIG. 29, the damping spindle mechanism with self compensation of this embodiment differs from the first embodiment in that: the oil passage is a first through hole 44 disposed in the blade along the axial direction.

### The Twelfth Embodiment

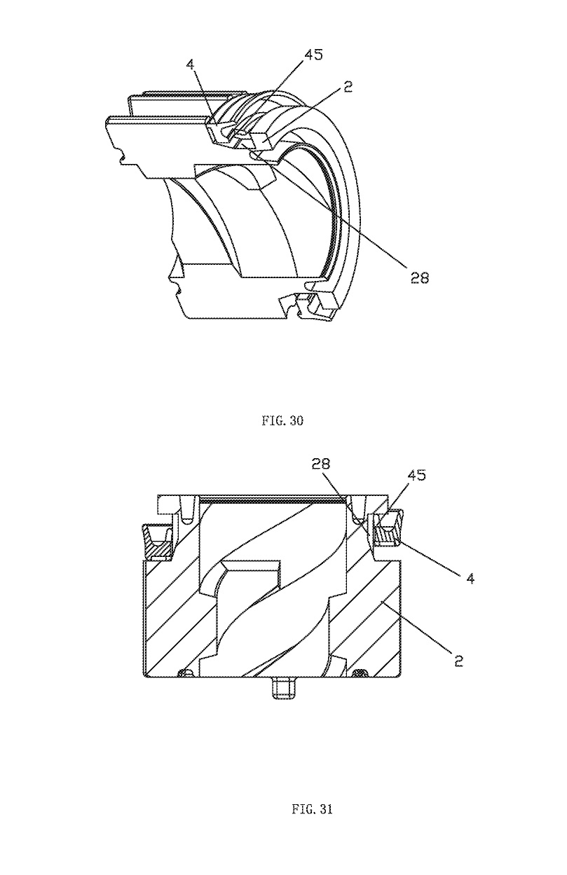

Referring to FIG. 30 and FIG. 31, the damping spindle mechanism with self compensation of this embodiment differs from the first embodiment in that: the oil passage is disposed between the blade and the sleeve, the oil passage comprises a gap 45 disposed at one single body of the blade 4 and a first groove 28 disposed at the sleeve corresponding to the gap.

As can be seen from above embodiments, the second passage can be independently disposed between the sleeve and the spindle, or between the sleeve and the housing; at the same way, the second passage can be disposed both between the sleeve and the spindle and between he sleeve and the housing, for example, the spindle has a central spindle with saltation internal diameter, the housing is applied with a chamber body with a gradually changing internal diameter; in another example, the central spindle of the spindle is disposed with an axial first a gradually changing first slot in the axial direction, the chamber wall of the chamber body of the housing is disposed with a gradient fifth slot in the axial direction; other combinations are available.

It should be noted that, the present invention can be applied widely, such as in the toilet seat cover, the fridge door, telephone flip cover, cabinet door and varies door/cover products, it can be also applied in a drawer, as the present invention is provided that the damping oil moves axially along the spindle, it has longer route than the case that the damping oil moves circumferentially along the spindle, therefore the rectilinear motion of the drawer is transformed to rotation of the spindle.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

### INDUSTRIAL APPLICABILITY

The present invention is provided with a self compensation mechanism that the first thin wall of the blade deforms towards the internal wall surface of the housing and the second thin wall deforms towards the external wall surface of the spindle when damping is needed, so that it can self compensate the gap due to mechanical wear to make the damping spindle mechanism keep in a stable state in long period, thus lengthening the service life of the damping spindle mechanism.

1. A damping spindle mechanism with self compensation, comprising a spindle, a sleeve, a housing and a blade; the sleeve is coupled to the spindle in thread way; an anti-rotation structure is disposed between the sleeve and the housing, when the spindle rotates, the sleeve moves forward and backward along the axis of the spindle in the housing; the housing is disposed with a chamber, one section of the spindle threaded with the sleeve is assembled in the chamber of the housing to form a closed chamber; the close chamber is filled with damping oil and is separated to a first chamber body and a second chamber body by the sleeve; the sleeve is disposed with a first passage connecting the two chamber bodies in the axial direction; wherein the blade is of ring shape or arc shape coupled to the internal wall surface of the housing, the blade is disposed with a deformable first thin wall, when the blade moves towards the second chamber body, the first thin wall deforms towards the internal wall surface of the housing.

2. The damping spindle mechanism with self compensation according to claim 1, wherein the internal wall of the sleeve is coupled to the external wall of the spindle, the internal wall of one end of the sleeve near the second chamber body is disposed with a second thin wall of deformation, when the sleeve moves towards the second chamber body, the thin wall deforms towards the external wall surface of the spindle.

3. The damping spindle mechanism with self compensation according to claim 1, wherein the blade is disposed with a first cavity adjacent to the first thin wall, the recess of the first cavity of the blade is faced to the second chamber body, so that when the blade moves towards the second chamber body, the recess of the first cavity opens the first thin wall outwards under the action of the damping oil.

4. The damping spindle mechanism with self compensation according to claim 2, wherein the sleeve is disposed with a second cavity adjacent to the second thin wall, the recess of the second cavity of the sleeve is faced to the second chamber body, so that when the sleeve moves towards the second chamber body, the recess of the second cavity opens the second thin wall outwards under the action of the damping oil.

5. The damping spindle mechanism with self compensation according to claim 1, wherein an oil passage is disposed in the blade or between the blade and the sleeve.

6. The damping spindle mechanism with self compensation according to claim 5, wherein the blade comprises at least two arc single bodies, the single bodies surrounds to a circle or the single bodies and the convex body of the sleeve surround to a circle so as to couple to the internal wall surface of the housing in a ring shape.

7. The damping spindle mechanism with self compensation according to claim 6, wherein the section of the single body is V shaped, U shaped, E shaped, T shaped, W shaped or C shaped.

8. The damping spindle mechanism with self compensation according to claim 5, wherein the oil passage is a first through hole disposed in the blade along the axial direction.

9. The damping spindle mechanism with self compensation according to claim 6, wherein the oil passage is disposed between the blade and the sleeve, the oil passage comprises a gap disposed at one single body of the blade and a first groove disposed at the sleeve corresponding to the gap.

10. The damping spindle mechanism with self compensation according to claim 6, wherein the oil passage is disposed between the blade and the sleeve, the oil passage comprises a through groove once formed at the at least one end of the single body of the blade and a fitting surface of the convex body of the sleeve, the fitting surface is an incline surface.

11. The damping spindle mechanism with self compensation according to claim 1, wherein the first passage is a second groove once formed at the external wall of the sleeve in the axial direction of the spindle.

12. The damping spindle mechanism with self compensation according to claim 1, wherein the first passage is a second through hole disposed at the sleeve in the axial direction of the spindle.

13. The damping spindle mechanism with self compensation according to claim 1, wherein the anti-rotation structure comprises a first rib disposed at the external wall of the sleeve in the axial direction and a second rib disposed at the internal wall of the housing in the axial direction, the first rib and the second rib are mismatched.

14. The damping spindle mechanism with self compensation according to claim 1, wherein a second passage is disposed between the first chamber body and the second chamber body to connect the two chamber bodies, the section of the second passage is reducing, so that the flow constant of the damping oil in the second passage changes.

15. The damping spindle mechanism with self compensation according to claim 14, wherein the second passage is disposed between the sleeve and the spindle.

16. The damping spindle mechanism with self compensation according to claim 15, wherein the spindle is disposed with a central spindle with reducing internal diameter, the internal diameter reducing central spindle and the sleeve surround to form the second passage, the internal diameter of the central spindle with reducing internal diameter is gradually increased from the end near the first chamber body to the other end near the second chamber body; or in other case, the spindle is disposed with a central spindle with saltation internal diameter, the central spindle with saltation internal diameter and the sleeve surround to from the second passage, the internal diameter of the central spindle with saltation internal diameter is suddenly increased from the end near the first chamber body to the other end near the second chamber body.

17. The damping spindle mechanism with self compensation according to claim 15, wherein the central spindle of the spindle is disposed with a gradually changing first slot in the axial direction, the gradually changing first slot and the sleeve surround to form the second passage, the gradually changing first slot is gradually narrowed from the end near the first chamber body to the other end near the second chamber body; or in other case, the central spindle of the spindle is a gradient second slot in the axial direction, the gradient second slot and the sleeve surround to form the second passage, the gradient second slot is gradiently narrowed from the end near the first chamber body to the other end near the second chamber body.

18. The damping spindle mechanism with self compensation according to claim 15, wherein the external thread of the spindle is disposed with gradually changing third slot in the thread direction, the gradually changing third slot and the sleeve surround to form the second passage, the gradually changing third slot is gradually narrowed in screw way from the end near the first chamber body to the other end near the second chamber body.

19. The damping spindle mechanism with self compensation according to claim 14, wherein the second passage is disposed between the sleeve and the housing.

20. The damping spindle mechanism with self compensation according to claim 19, wherein the housing is disposed with a chamber body with internal diameter gradually changing, the chamber wall of the chamber body with internal diameter gradually changing and the sleeve surround to form the second passage, the internal diameter of the chamber body with internal diameter gradually changing is gradually narrowed from the end near the first chamber body to the other end near the second chamber body; or in other case, the housing is disposed with a chamber body with saltation internal diameter, the chamber wall of the chamber body with saltation internal diameter and the sleeve surround to form the second passage, the internal diameter of the chamber body with saltation internal diameter is suddenly decreased from the end near the first chamber body to the other end near the second chamber body.

21. The damping spindle mechanism with self compensation according to claim 19, wherein the chamber wall of the chamber body of the housing is disposed with a gradually changing fourth slot in the axial direction, the gradually changing fourth slot and the sleeve surround to form the second passage, the gradually changing fourth slot is gradually narrowed from the end near the first chamber body to the other end near the second chamber body; or in other case, the chamber wall of the chamber body of the housing is disposed with a gradient fifth slot in the axial direction, the gradient fifth slot and the sleeve surround to form the second passage, the gradient fifth slot is gradiently narrowed from the end near the first chamber to the other end near the second chamber body.
